(19) United States
(12) Patent Application Publication
(10) Pub. No.: US 2008/0164307 A1
(43) Pub. Date: Jul. 10, 2008

(54) PERFORMING TRANSACTIONS WITH UNIVERSAL TRANSACTION CARD

(75) Inventor: Dana L. Silverstein, Duvall, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/620,247

(22) Filed: Jan. 5, 2007

(51) Int. Cl. G06F 17/00; G06K 19/06

(52) U.S. Cl. 235/380; 235/494

(57) ABSTRACT

The present invention extends to methods, systems, and computer program products for performing transactions with a universal transaction card. A computer system in a specified venue submits an accessed card serial number, corresponding to a detected universal transaction card, to a card management system. The universal transaction card is authenticated, and the card management system returns venue specific content back to the computer system. The computer system presents the venue specific content. A user at computer system can then interact with venue specific content to perform venue specific transactions. Accordingly, embodiments of the present invention facilitate the use of a single passive card that can uniquely identify customers, display and access venue specific information, and automatically charge users for products and services.

### CROSS-REFERENCE TO RELATED APPLICATIONS

Not Applicable.

### BACKGROUND

### Background and Relevant Art

Computer systems and related technology affect many aspects of daily life in society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing components.

For example, in retail purchasing environments authorizing a credit card or debit card purchase typically includes network communication between a retailer and an authorizing entity to verify available credit. Similarly, withdrawal of funds using a debit card or ATM card includes network communication between an ATM machine and a banks accounting system to verify available funds.

In other environments, network communication can be used to credit (or “load”) funds into a purchasing card and then debit the card when purchases are made using the card. These types of purchasing cards are typically vendor specific and the associated balance of the card is managed by a vendor and not separate financial institution. For example, a patron of a coffee shop can obtain a purchasing card from the coffee shop. The patron can give the coffee shop some amount of money in exchange for crediting the purchasing card by the same amount, such as, for example, by storing the amount in a magnetic strip on the card. Then, when the patron wishes to purchase an item at the coffee shop, the card is swiped to read the stored amount, and if the stored amount is sufficient, the stored amount is debited by the cost of the purchased item. The purchasing card can be credited with ample funds for multiple purchases such that the card can be credited less frequently than each time the patron purchases an item from the coffee shop. Accordingly, the patron has the convenience of simply carrying the purchasing card as opposed to always needing cash to make a purchase.

However, since purchasing cards are vendor specific, a patron is required to have a purchasing card for each vendor they frequent. Thus, a patron may be required to carry multiple cards. Further, purchasing cards store a limited amount of information and are not able to uniquely identify the possessor of the card. Thus, purchasing cards typically can not be tied to the owner. As a result, if a purchasing card is lost, anyone who finds the purchasing card can use it. Further, since purchasing cards are managed on a per vendor basis, and typically not tied to credit card payments or debit card payments, management of purchasing cards can be more cumbersome. For example, if a vendor manages its own financial system to track purchasing card balances, the vendor can not rely on nor take advantage of the efficiencies inherent in financial systems of banks and/or credit card companies.

### BRIEF SUMMARY

The present invention extends to a universal transaction card and methods, systems, and computer program products for performing transactions with a universal transaction card. A universal transaction card includes a rigid polymeric substrate having a first side and a second different side. The rigid polymeric substrate has at least an opaque portion and potentially also includes a clear portion. The clear portion is sufficiently transparent such that video display data presented on a presentation surface of a computer system is visible through the clear portion when the clear portion is placed in physical contact with the presentation surface of a computer system.

Card related information (card number, card management contact information, etc.) is inscribed on the first side of the opaque portion. A readable bar code is printed on the second side of the opaque portion. A wireless communication chip is embedded within the opaque portion. A magnetic strip is attached to the second side of the rigid polymeric substrate.

In some embodiments, a computer system detects that a universal transaction card has come into physical contact with a portion of the presentation surface of a computer system. The computer system accesses a card serial number corresponding to the detected universal transaction card. The computer system submitting the card serial number and a venue identifier for the specified venue to a card management system.

The card managements system receives the card serial number and the venue identifier from a computer system. The card serial number indicates that the computer system detected that the universal transaction card has come into physical contact with a portion of the presentation surface of the computer system. The card management system sends an authentication request to the computer system to authenticate the universal transaction card.

The computer system receives the authentication request to authenticate use of the detected universal transaction card. The computer system presents a virtual authentication interface for authenticating the detected universal transaction card. The virtual authentication interface is presented on the presentation surface in proximity to the portion of the presentation surface where the physical contact was detected and in accordance with the authentication request. The computer system receives user-entered authentication information entered through the virtual authentication interface. The computer system sends the user-entered authentication information to the card management system.

The card management system receives the user-entered authentication information corresponding to the authentication request from the computer system. The card management system authenticates the universal transaction card based on the received authentication information. The card management system identifies venue specific content for the owner of the universal transaction card in response to authenticating the universal transaction card and based on the venue identifier. The venue specific content specific to the specified venue and identified from among content corresponding to a plurality of different venues associated with the owner. The card management system sends the venue specific content to the computer system for presentation on the presentation surface in proximity to the physically contacted portion of the presentation surface.

The computer system receives the venue specific content corresponding to the owner of the universal transaction card. The computer system presents the venue specific content on the presentation surface in proximity to the portion of the presentation surface where the physical contact was detected.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a universal transaction card.

FIG. 2 illustrates an example computer architecture that facilitates performing transactions with a universal transaction card.

FIG. 3 illustrates a flowchart of a method for performing transactions with a universal transaction card.

### DETAILED DESCRIPTION

The present invention extends to a universal transaction card and methods, systems, and computer program products for performing transactions with a universal transaction card. A universal transaction card includes a rigid polymeric substrate having a first side and a second different side. The rigid polymeric substrate has at least an opaque portion and potentially also includes a clear portion. The clear portion is sufficiently transparent such that video display data presented on a presentation surface of a computer system is visible through the clear portion when the clear portion is placed in physical contact with the presentation surface of a computer system.

Card related information (card number, card management contact information, etc.) is inscribed on the first side of the opaque portion. A readable bar code is printed on the second side of the opaque portion. A wireless communication chip is embedded within the opaque portion. A magnetic strip is attached to the second side of the rigid polymeric substrate.

In some embodiments, a computer system detects that a universal transaction card has come into physical contact with a portion of the presentation surface of a computer system. The computer system accesses a card serial number corresponding to the detected universal transaction card. The computer system submitting the card serial number and a venue identifier for the specified venue to a card management system.

The card managements system receives the card serial number and the venue identifier from a computer system. The card serial number indicates that the computer system detected that the universal transaction card has come into physical contact with a portion of the presentation surface of the computer system. The card management system sends an authentication request to the computer system to authenticate the universal transaction card.

The computer system receives the authentication request to authenticate use of the detected universal transaction card. The computer system presents a virtual authentication interface for authenticating the detected universal transaction card. The virtual authentication interface is presented on the presentation surface in proximity to the portion of the presentation surface where the physical contact was detected and in accordance with the authentication request. The computer system receives user-entered authentication information entered through the virtual authentication interface. The computer system sends the user-entered authentication information to the card management system.

The card management system receives the user-entered authentication information corresponding to the authentication request from the computer system. The card management system authenticates the universal transaction card based on the received authentication information. The card management system identifies venue specific content for the owner of the universal transaction card in response to authenticating the universal transaction card and based on the venue identifier. The venue specific content specific to the specified venue and identified from among content corresponding to a plurality of different venues associated with the owner. The card management system sends the venue specific content to the computer system for presentation on the presentation surface in proximity to the physically contacted portion of the presentation surface.

The computer system receives the venue specific content corresponding to the owner of the universal transaction card. The computer system presents the venue specific content on the presentation surface in proximity to the portion of the presentation surface where the physical contact was detected.

Embodiments of the present invention may comprise a special purpose or general-purpose computer including computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, computer-readable media can comprise physical (or recordable type) computer-readable storage media, such as, RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer, the computer properly views the connection as a computer-readable medium. Thus, by way of example, and not limitation, computer-readable media can also comprise a network or data links which can be used to carry or store desired program code means in the form of computer-executable instructions or data structures and which can be accessed by a general purpose or special purpose computer.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, table top computers, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

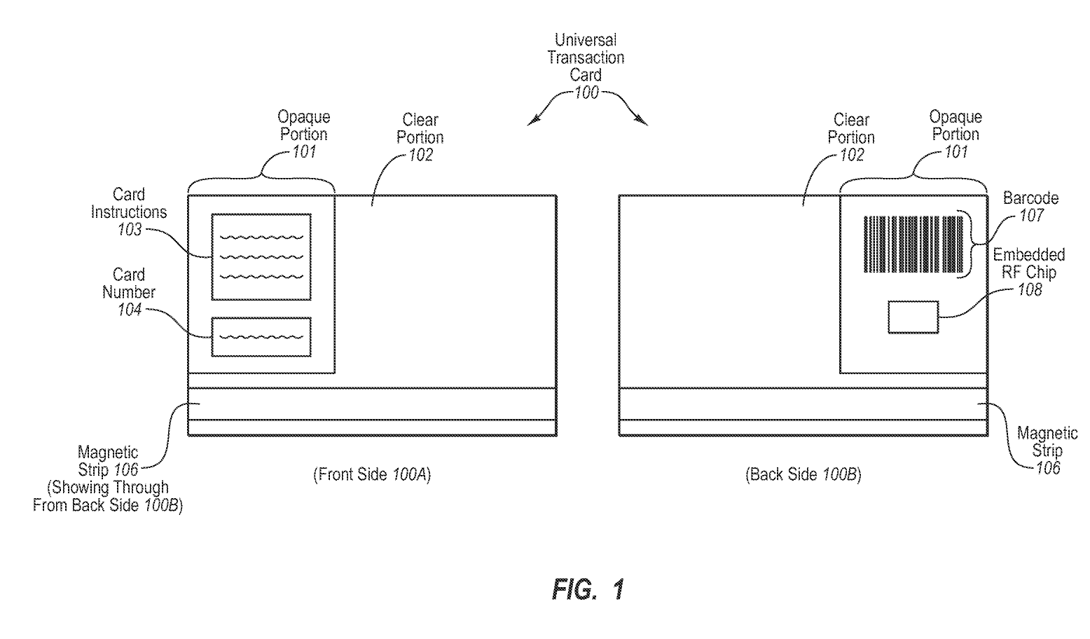

FIG. 1 illustrates an example of a universal transaction card 100. As depicted universal transaction card 100 includes front side 100A and back side 100B. Universal transaction card 100 also includes opaque region 101 and clear region 102. Opaque region 101 can be sufficiently opaque such that video display data presented on a presentation surface of a computer system is not visible through the opaque portion. On the other hand, clear portion 102 can be sufficiently transparent such that video display data presented on a video presentation surface (e.g., a computer system display device or television monitor) is visible through clear portion 102 at least when clear portion 102 is in physical contact with the presentation surface. However, depending in part on the opacity of clear portion 102, video display data presented on a video presentation surface can also be visible through clear portion 102 when universal transaction card 100 is some distance (e.g., in inches) above the video presentation surface.

Generally, card related information (e.g., card number, card management contact information, etc.) can be inscribed on front side 100A within opaque portion 101. For example, front side 100A includes card instructions 103 and card number 104 inscribed (e.g., printed) within opaque portion 101. Card instructions 103 can include instructions for adding funds to or checking the balance of universal transaction card 100. Card instructions 103 can also includes instructions for accessing card features, accessing list of available brands supporting the card, accessing what services (e.g., credit card services, debit card services, information retrieval services, etc.) can be associated with the card per brand. Card number 104 can be a unique card number assigned to universal transaction card 100 (e.g., by a corporation that runs a card management system)

A unique (per card management system) bar code can be inscribed on back side 100B within opaque portion 101. For example, bar code 107 is inscribed on back side 100B within opaque portion 101. Information included in bar code 107 can represent a unique card serial number (e.g., potentially different than the unique card number) for universal transaction card 100. Bar code 107 can be read by a vision based (e.g., Infrared) reader to access the unique card serial number for universal transaction card 100.

Universal transaction card 100 can also include an embedded wireless chip that transmits the unique card serial number. For example, embedded Radio Frequency (“RF”) chip is embedded in opaque portion 101. Embedded RF chip 107 can be a Near Field Communication (NFC) RFID chip that transmits the unique card serial number for universal transaction card 100. The transmitted unique card serial number can be read by a corresponding wireless (e.g., RF) receiver.

Thus, universal transaction card can include a plurality of different mechanisms for providing the unique card serial number for universal transaction card 100. This increases the likelihood that computer systems within a particular venue (e.g., store, restaurant, airport, etc.) are able to access the unique card serial number for universal transaction card 100. However, in some embodiments, a universal transaction card has either an inscribed bar code or an embedded wireless chip, but not both.

Universal transaction card 100 can also include a magnetic strip that can be swiped through a (e.g., credit) card reader. Generally, a magnetic strip can be on either side of a card and within an opaque and/or clear portion of the card. As depicted in FIG. 1, for example, universal transaction card 100 includes magnetic strip 106. Magnetic strip 106 is affixed to back side 100B. However, magnetic strip 106 is also visible through clear portion 102 on front side 100A. Magnetic strip 106 can encode the unique card serial number for universal transaction card 100. Swiping magnetic strip 106 through a card reader provides another (e.g., backup) mechanism to access the unique card serial number for universal transaction card 100. Magnetic strip 106 can be swiped, for example, when a vision reader and/or wireless receiver are not available or are not functioning properly. However, in some embodiments, a universal transaction card does not include a magnetic strip.

Universal transaction card 100 can be constructed from a rigid polymeric substrate, such as, for example, a plastic, a ceramic, or a glass substrate. In some embodiments, different portions of the universal transaction card 100 (e.g., opaque and clear) comprise different types of rigid polymeric substrates. Universal transaction card 100 can be of a size that is easily transported by a human, for example, carried within a pocket or purse. In some embodiments, universal transaction card 100 is has the dimension of a standard credit card (e.g., approximately 85.6 mm (3.37 in) wide×53.98 mm (2.13 in) high). However, universal transaction card 100 can be of any size that can be either partially or wholly placed in physical contact with the presentation surface of a computer system.

In other embodiments, a universal transaction card is essentially completely opaque. Completely opaque universal transactions cards can include any of the components described with respect to universal transaction card 100, such as, for example, card instructions, a card number, a magnetic strip, a bard card and am embedded RF chip. Information similar to that described with respect to universal transaction card 100 can be stored in these components.

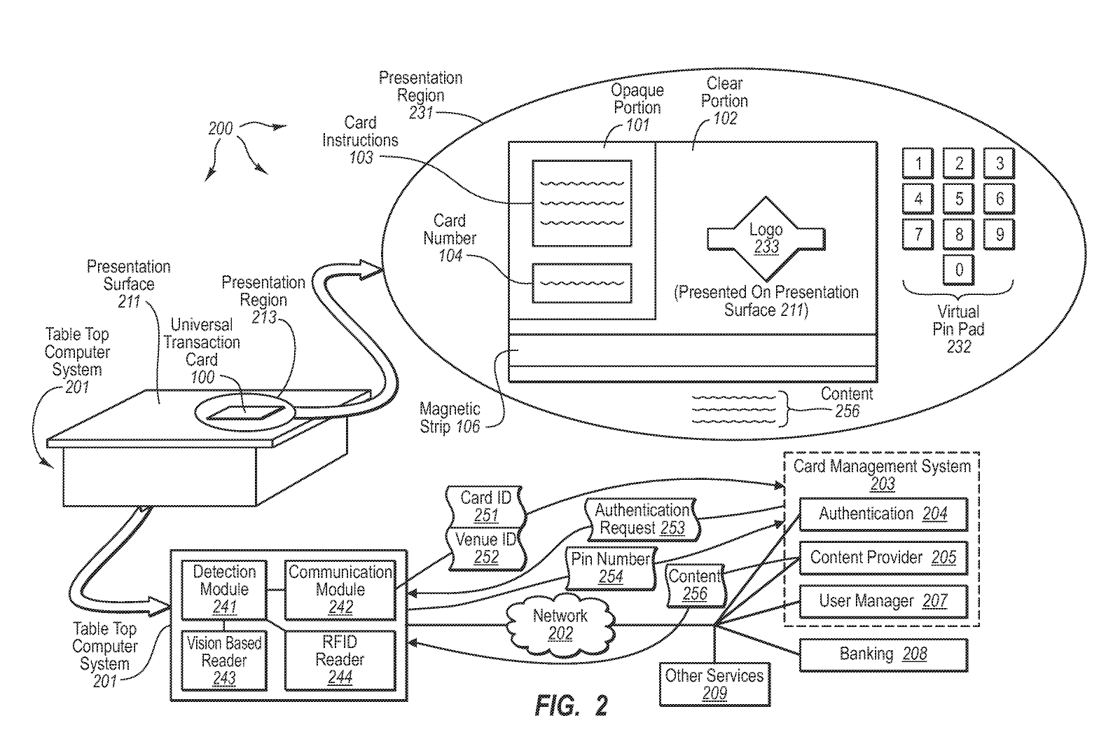

FIG. 2 illustrates an example computer architecture 200 that facilitates performing transactions with a universal transaction card. Depicted in computer architecture 200 are various components including table top computer system 201, card management system 203, banking 208, and other services 209. Each of the various components can be connected to network 202, such as, for example, a Local Area Network (“LAN”), a Wide Area Network (“WAN”), or even the Internet. Thus, the various components can receive data from and send data to other components connected to the network. Accordingly, the components can create message related data and exchange message related data (e.g., using Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (“SOAP”) envelopes, etc.) over network 202.

Generally, table top computer system 201 can be location in private, semi-private, or public venue, such as, for example, a restaurant, a bar, a club, an airport, a theater, a restaurant, etc., where a user can interact with a computer. Table top computer system 201 can have the physical characteristics of a table, such as, for example, a checkout stand, with presentation surface 211 configured to present content on the table top such that when a user (or patron) looks at the table top they can view presented content. The venue can be associated with a venue identifier that can be used by a card management system to tailor content for presentation at presentation surface 211.

Generally, table top computer system 201 is configured to present content related to a physical object in response to detection of the physical object. Table top computer system 201 includes detection module 241, communication module 242, vision based reader, and RFID reader 244. Detection module 241 can be configured to detect when a physical object (e.g., a bottle, a glass, a finger, a hat, universal transaction card 100, etc.) has come into physical contact with a portion of presentation surface 211. Presentation surface 211 can include (e.g., embedded) sensors, such as, for example, pressure sensors, temperature sensors, image scanners, light sensors, etc., that interoperate with detection module 241 to detect physical contact between a physical object and the presentation surface. Light sensors and/or image scanners can used to determine that an object has a clear portion through which video display data can be viewed.

In some embodiments, presentation surface 211 includes sensors for implementing a touch screen interface. For example, presentation surface 211 can include an interactive multi-touch surface.

Sensors can be included (e.g., embedded) in a plurality of locations across presentation surface 211. Detection module 241 can be configured to interoperate with sensors individually or as subsets such that detection module 241 can differentiate locations where physical contact with the presentation surface has occurred. Thus, detection module 143 can differentiate between contact at a plurality of different locations on the presentation surface 211 simultaneously.

Detection module 241 can also be configured to determine the type of a physical object that has physically contacted the presentation surface of table top computer system 201. Detection module can interoperate with the sensors included (e.g., embedded) in the presentation surface 211 and potentially other sensors (e.g., vision based reader 243 and RFID reader 244) of table top computer system 201 to determine a physical object type. For example, in response to one or more embedded pressure sensors detecting physical contact with a portion of the presentation surface, a Radio Frequency (“RF”) scanner can then scan for RF chips attached to a contacting physical object. Thus, one sensor or subset of sensors can be used to detect physical contact with an object and another sensor or subset of sensors can be used to determine the type of the object that caused the contact.

In another detection example, after pressure sensors detect contact an image scanner can be used to scan the physical characteristics at and/or around the location of the physical contact. From the scanned data, detection module 241 can determine the type of physical object contacting the presentation surface. For example, if universal transaction card 100 is placed on presentation surface 211, a scanner can scan a side universal transaction card 100 to generate scan data. The scanner can then send the scan data to detection module 241. From the scan data, detection module 241 can determine that the contacting object is a universal transaction card. Detection module 241 can have access to previously scanned images (e.g., including product logos, product dimensions, etc.) to facilitate object type determinations.

When a universal transaction card is the identified object type, detection module 241 can access a unique card serial number corresponding to the universal transaction card. For example, the unique card serial number can be read from an embedded wireless chip (e.g., embedded RF chip 108) or scanned form a bar code (e.g., bar code 107) attached to the universal transaction card. For example, RFID reader 244 can receive a unique card serial number being transmitted by embedded RF chip 108. Alternately, vision based reader 243 can read the unique card serial number barcode 107.

Communication module 242 is configured to communicate with other computer systems via network 202. Communication module 242 can be configured to compatible communication using a variety of different communication protocols.

Card management system 203 is configured to manage universal transaction cards. Authenticator 204 can a unique serial code number for a universal transaction card and credentials (e.g., a pin or password) and determine if the credentials are correct for the universal transaction card. When credentials for a universal transaction card are correct, authenticator 204 can authorize transactions using the universal transaction card.

Content provider 206 is configured to provide venue specific content based on the venue where a universal transaction card is detected. Content provider 206 can have access to content for a plurality of different brands and locations. Content provider 206 can receive an electronic address (e.g., an IP address) for a computer system. From the electronic address, content provider 206 can determine the brand associated with and/or location of the computer system. Content provider 106 can then return relevant and appropriate brand and/or location content for presentation at the computer system.

Content provider 106 can also vary returned content based on owner profile information associated with a universal transaction card. Content provider 106 can return different content based on the age, race, sex, prior purchasing habits, owner selected content preferences, etc., of a universal transaction card user. For example, one portion of content can be returned when an 18 year old male purchases a video game at a toy store. However, a second different portion of content can be returned when a 35 year old female purchases a child's board game at the toy store.

Brands and/or locations can provide content provider 206 with content. Content provider 206 can store the content along with the corresponding brands and/or locations that provided the content. Content provider 206 can also store a list or table that maps electronic address (e.g., IP addresses) to brands and/or locations. Thus, when an electronic address is received from a computer system, content provider 206 can scan the table and identify the corresponding brand and/or location where a computer system with the received electronic address is located. Using the identified brand and/or location, content provider 206 can then access relevant and appropriate stored content.

User manager 207 is configured to provide an (e.g., Web based) interface for universal transaction card owners to manage their universal transaction card. For example, through user manager 207 owners can set personal information, select content preferences, check the balance of their card, transfer money to their card, etc. User manager 207 can also be used to associate the card with additional venues (e.g., brands and/or locations). For example, through User manager 207 a card owner can register to use the card in additional venues.

Registering for additional venues can add card functionality. For example, if a card is registered for use with an airline, the card can be given the functionality to retrieve frequent flier balances. If a card is registered for use in a department store, the card can be given debit and/or credit card functionality. The addition of other functionalities appropriate for consumer transactions is also possible. Thus, a universal transaction card can be utilized in a plurality of different venues and can provide different functionality in different venues. Accordingly, a universal transaction card allows a consumer to reduce the number of different cards (to potentially a single card) needed to perform different transactions in different venues.

Card management system 203 can interoperate with banking 208 and other services 209 to facilitate purchasing and other transactions, such as, for example, checking balances, transferring money, accessing frequent flyer miles, accessing loyalty points, accessing subscriptions, accessing promotions, accessing advertisements, etc.

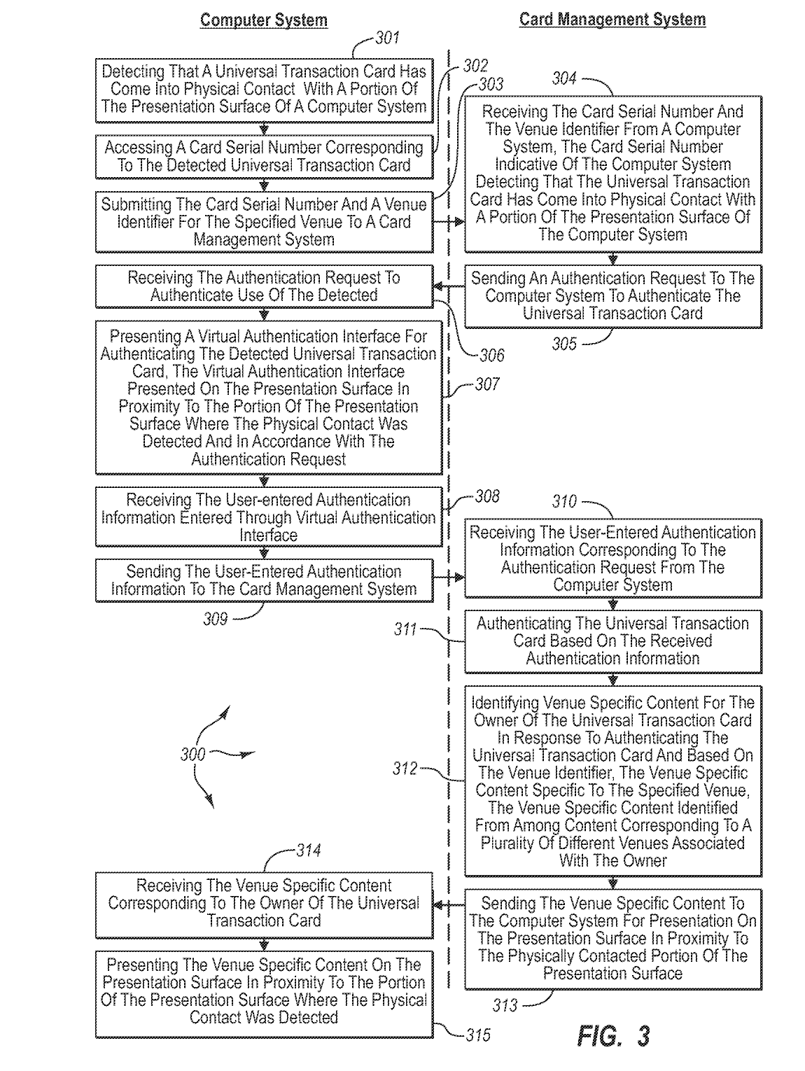

FIG. 3 illustrates a flowchart of a method 300 for performing transactions with a universal transaction card. The method 300 will be described with respect to the components and data depicted in computer architecture 200.

Method 300 includes an act of detecting that a universal transaction card has come into physical contact with a portion of the presentation surface of the computer system (act 301). For example, detection module 241 can interact with sensors of presentation surface 211 to detect that universal transaction card 100 has come into physical contact with a portion of presentation surface 211. Alternately, detection module 241 can detect that an essentially completely opaque card has come into physical contact with a portion of presentation surface 211.

Method 300 includes an act of accessing a card serial number corresponding to the detected universal transaction card (act 302). For example, vision based reader 243 can read card ID 251 (a card serial number for universal transaction card 100) from bar code 107. Alternately, RFID reader 244 can receive card ID 251 from embedded RF chip 108.

Method 300 includes an act of submitting the card serial number and a venue identifier for the specified venue to a card management system (act 303). For example, communication module 242 can submit card ID 251 and venue ID 252 (corresponding to the venue where table top computer system 201 is located) to card management system 203. In some embodiments, venue ID 252 is the electronic (e.g., IP) address of table top computer system 201.

Method 300 includes an act of receiving the card serial number and the venue identifier from a computer system in a specified venue, the card serial number indicative of the computer system detecting that the universal transaction card has come into physical contact with a portion of the presentation surface of the computer system (act 304). For example, card management system 203 can receive card ID 251 and venue ID 252 from table top computer system 201. Card ID 251 indicates to card management system 203 that a universal transaction card came into physical contact with presentation surface 211.

Method 300 includes an act of sending an authentication request to the computer system to authenticate the universal transaction card (act 305). For example, card management system 203 can send authentication request 253 to table top computer system 201. Method 200 includes an act of receiving the authentication request to authenticate use of the detected universal transaction card (act 306). For example, table top computer system 201 can receive authentication request 253 from card management system 203. Authentication request 253 can indicate the type of authentication, such as, for example, PIN number, password, secret code, etc., that is to be performed.

Method 300 includes an act of presenting a virtual authentication interface for authenticating the detected universal transaction card, the virtual authentication interface presented on the presentation surface in proximity to the portion of the presentation surface where the physical contact was detected and in accordance with the authentication request (act 307). For example, table top computer system 201 can present a virtual authentication interface for authenticating universal transaction card 100. The virtual authentication interface can be presented on presentation surface 211 in proximity to the portion of presentation surface 211 where physical contact with universal transaction card 100 was detected.

The virtually authentication interface can be configured to permit the entry of information responsive to the type of authentication that is to be performed. For example, as depicted in the expanded view of presentation region 213, virtual pin pad 232 can be presented to permit the entry of a PIN number for universal transaction card 100. Alternately, a virtual keyboard can be presented to permit entry of a user-name and/or password.

Further depicted in the expanded view of presentation region 213, logo 233 (e.g., of a specified brand) is also presented on presentation surface 211 and is visible through clear portion 102. Other content can also be presented on presentation surface 221 and visible though clear portion 102 and/or in proximity to universal transaction card 100 to provide general information, advertising, etc. and/or to facilitate authentication. When an essentially completely opaque universal transaction card is detected, content can be presented in proximity to the universal transaction card.

Method 300 includes an act of receiving user-entered authentication information entered through the virtual authentication interface (act 308). For example, table top computer system 201 can receive a PIN number 254 entered through virtual pin pad 232. Method 300 includes an act of sending the authentication information to the card management system (act 309). For example, communication module 242 can send PIN number 242 (or when appropriate a user-name and password) to authenticator 204.

Method 300 includes an act of authenticating the universal transaction card based on the received user-entered authentication information (act 310). For example, authenticator 204 can authenticate universal transaction card 100 based on PIN number 254 (or when appropriate a user-name and password). Authenticator 204 can refer to an authentication database that maps card numbers to authentication information to determine that PIN number 254 (or a user-name and password) is the appropriate authentication information for universal transaction card 100.

Method 300 includes an act of identifying venue specific content for the owner of the universal transaction card in response to authenticating the universal transaction card and based on the venue identifier, the venue specific content specific to the specified venue, the venue specific content identified from among content corresponding to a plurality of different venues associated with the owner (act 311). For example, content provider 206 can identify venue specific content 256 for the owner of universal transaction card 100 in response to authenticator 204 authenticating universal transaction card 100. Content provider 206 can consider the brand and/or location corresponding to table top computer system 201 as well as profile information for the owner of universal transaction card 100 when selecting venue specific content 256. Venue specific content 256 can be selected for a specified venue from among a plurality of venues associated with the owner of universal transaction card 100. Venue specific content 256 can include a banking interface for accessing banking information, a loyalty program interface for accessing loyalty program information, advertisements, promotional information, digital coupons, a virtual shopping cart interface for purchasing items, etc.

Method 300 includes an act of sending the venue specific content to the computer system for presentation on the presentation surface in proximity to the physically contacted portion of the presentation surface (act 313). For example, content provider 206 can send venue specific content 256 to table top computer system 201 for presentation on presentation surface 211 in proximity to universal transaction card 100 (e.g., within presentation region 231). Method 300 includes an act of receiving the venue specific content corresponding to the owner of the universal transaction card (act 314). For example, table top computer system 201 can receive venue specific content 256 from content provider 206.

Method 200 includes an act of presenting the venue specific content on the presentation surface in proximity to the portion of the presentation surface where the physical contact was detected (act 315). For example, table top computer system 210 can present venue specific content 256 on presentation surface 211 in proximity to universal transaction card 100 (e.g., within presentation region 231). Venue specific content 256 can overwrite virtual pin pad 232. Venue specific content 256 can also modify or overwrite logo 233 that is visible through clear portion 102. Subsequent to presentation, a user can interact with venue specific content 256 to perform various venue appropriate consumer transactions. For example, in a department store a user can use a shopping cart interface to purchase items. In a bank, a user can use banking interface to transfer funds between accounts, view statement information, etc.

Accordingly, embodiments of the present invention facilitate the use of a single passive card that can uniquely identify customers, display and access venue specific information, and automatically charge users for products and services.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. At a computer system within a specified venue, the computer system including a presentation surface for presenting content, a method for presenting venue specific content for an owner of a universal transaction card, the method comprising:
an act of detecting that a universal transaction card has come into physical contact with a portion of the presentation surface of the computer system;
an act of accessing a card serial number corresponding to the detected universal transaction card;
an act of submitting the card serial number and a venue identifier for the specified venue to a card management system;
an act of receiving an authentication request to authenticate use of the detected universal transaction card;
an act of presenting a virtual authentication interface for authenticating the detected universal transaction card, the virtual authentication interface presented on the presentation surface in proximity to the portion of the presentation surface where the physical contact was detected and in accordance with the authentication request;
an act of receiving user-entered authentication information entered through the virtual authentication interface;
an act of sending the authentication information to the card management system;
an act of receiving venue specific content corresponding to the owner of the universal transaction card; and
an act of presenting the venue specific content on the presentation surface in proximity to the portion of the presentation surface where the physical contact was detected.

2. The method as recited in claim 1, further comprising:
an act of determining that the detected universal transaction card includes a clear portion that is sufficiently transparent such that video display data presented on a presentation surface underneath the clear portion is visible through the clear portion; and
an act presenting a venue specific logo on the presentation surface underneath the clear portion of the universal transaction card.

3. The method as recited in claim 1, wherein the act of detecting that a universal transaction card has come into physical contact with a portion of the presentation surface of the computer system comprises an act of one or more sensors embedded in the presentation surface detecting that the universal transaction card has come into physical contact with a portion of the presentation surface.

4. The method as recited in claim 1, wherein the act of accessing a card serial number corresponding to the detected universal transaction card comprises an act of a vision based reader reading a card serial number from a bar code inscribed on the universal transaction card.

5. The method as recited in claim 1, wherein the act of accessing a card serial number corresponding to the detected universal transaction card comprises an act of a wireless receiver receiving a transmission including the card serial number, the transmission sent from a wireless chip embedded in the universal transaction card.

6. The method as recited in claim 1, wherein the an act of submitting the card serial number and a venue identifier for the specified venue to a card management system comprises an act of submitting the card serial number and an electronic address of the computer system to the card management system.

7. The method as recited in claim 1, wherein the act of presenting a virtual authentication interface for authenticating the detected universal transaction card comprises an act of presenting a virtual pin pad on the presentation surface.

8. The method as recited in claim 1, wherein the act of receiving user-entered authentication information entered through virtual authentication interface comprises an act of receiving a pin number or password entered through virtual authentication interface.

9. The method as recited in claim 1, wherein the act of receiving venue specific content corresponding to the owner of the universal transaction card comprises an act of receiving venue specific content including one of a banking interface, a virtual shopping cart, a brand loyalty interface, an advertisement, promotional information, and a digital coupon

10. The method as recited in claim 1, wherein the act of presenting the venue specific content on the presentation surface in proximity to the portion of the presentation surface where the physical contact was detected comprises an act of presenting venue specific content including one of banking interface, a virtual shopping cart, a brand loyalty interface, an advertisement, promotional information, and a digital coupon.

11. The method as recited in claim 1, wherein the act of presenting the venue specific content on the presentation surface in proximity to the portion of the presentation surface where the physical contact was detected comprises an act of presenting a user-interface to permit a user to perform a venue specific function.

12. The method as recited in claim 1, wherein the act of presenting the venue specific content on the presentation surface in proximity to the portion of the presentation surface where the physical contact was detected comprises an act of presenting venue specific content on a presentation surface of a table top computer system

13. At a card management system, a method for providing venue specific content for an owner of a universal transaction card, the method comprising:
an act of receiving a card serial number and a venue identifier from a computer system in a specified venue, the card serial number indicative of the computer system detecting that a universal transaction card has come into physical contact with a portion of the presentation surface of the computer system;
an act of sending an authentication request to the computer system to authenticate the universal transaction card;
an act of receiving user-entered authentication information corresponding to the authentication request from the computer system;
an act of authenticating the universal transaction card based on the received user-entered authentication information;
an act of identifying venue specific content for the owner of the universal transaction card in response to authenticating the universal transaction card and based on the venue identifier, the venue specific content specific to the specified venue, the venue specific content identified from among content corresponding to a plurality of different venues associated with the owner;
an act of sending the venue specific content to the computer system for presentation on the presentation surface in proximity to the physically contacted portion of the presentation surface.

14. The method as recited in claim 13, wherein the act of receiving a card serial number and a venue identifier from a computer system in a specified venue comprises an act of receiving a card serial number and an electronic address of the computer system.

15. The method as recited in claim 13, wherein the act of receiving user-entered authentication information corresponding to the authentication request from the computer system comprises an act of receiving a PIN number or password for the owner of the universal transaction card.

16. The method as recited in claim 13, wherein the an act of identifying venue specific content for the owner of the universal transaction card comprises identifying venue specific content based on the brand and location associated with the venue identifier

17. The method as recited in claim 13, wherein the an act of identifying venue specific content for the owner of the universal transaction card comprises identifying venue specific content based on preferences of the universal transaction card owner.

18. The method as recite din claim 13, wherein identifying venue specific content for the owner of the universal transaction card comprises an act of identifying venue specific content selected from among a banking interface, a virtual shopping cart, a brand loyalty interface, an advertisement, promotional information, and a digital coupon.

19. The method as recite din claim 13, wherein identifying venue specific content for the owner of the universal transaction card comprises an act of identifying a user-interface to permit a user to perform a venue specific function.

20. A universal transaction card for performing consumer transactions, the universal transaction card comprising:
a rigid polymeric substrate having a first side and a second different side, the rigid polymeric substrate including:
an opaque portion; and
a clear portion, the clear portion being sufficiently transparent such that video display data presented on a presentation surface of a computer system is visible through the clear portion when the clear portion is placed in physical contact with the presentation surface of the computer system; and
wherein card related information is inscribed on the first side of the opaque portion;
wherein a readable bar code, representing a card serial number of the universal transaction card, is printed on the second side of the opaque portion;
wherein a wireless communication chip is embedded within the opaque portion, the wireless communication chip transmitting the card serial number; and
wherein a magnetic strip is attached to the rigid polymeric substrate, the magnetic strip encoding the card serial number.
